(19) United States
(12) Patent Application Publication
(10) Pub. No.: US 2011/0142701 A1
(43) Pub. Date: Jun. 16, 2011

(54) Pump with a Sculptured Fluid End Housing

(75) Inventor: Tony M. Small, Mansfield, TX (US)

(73) Assignee: FRAC TECH SERVICES, LTD., Cisco, TX (US)

(21) Appl. No.: 12/635,159

(22) Filed: Dec. 10, 2009

(51) Int. Cl. F04B 41/06; B23P 15/00

(52) U.S. Cl. 417/521; 29/888.02

(57) ABSTRACT

This invention relates to a method of fabricating or machining the fluid end of a high pressure pump and a fluid end produced by the method. The method includes sculpturing the front side of the fluid end which results in a non-planar surface. In this manner the internal stresses can be varied at critical points within the fluid end.

### BACKGROUND OF INVENTION

1. Field of the Invention

This invention relates to the design of fluid pumps used for pumping fluid at a relatively high pressure into a well. One example of such a process is the hydraulic fracturing process for oil and/or gas well applications. These pumps are commonly referred to as frac pumps. Other uses may include pumping cement or other fluids into the well.

In the case of frac pumps, the pumps are typically mounted on a truck/trailer and several may be used in series or in parallel to pump the fracturing fluid under high pressure into the well. As fracturing techniques become more popular and productive there is a continuing need to increase the horsepower capability of the pumps and the flow rate. However, as horsepower and operating pressures increase, so does the size of the pump and the failure rate.

The present invention addresses techniques to balance and/or modify stress loads within the pump housing which permits larger capacity pumps to be fabricated using lighter housings than previously thought possible with less failure.

2. Description of Related Art

Known frac pumps comprise generally two sections, the power end and the fluid end. The power end includes a housing for the drive shafts for the reciprocating pistons that extend into the fluid end. The fluid end includes the inlet ports, outlet ports and the cylinders for the reciprocating pistons. The two ends are normally bolted together. The fluid end may include up to five or more separate fluid pump chambers. Examples of this type of pump can be found in U.S. Pat. Nos. 6,419,459 B1 and 7,341,435 B2. Currently the fluid end of the pump tends to be damaged due to pressure imbalances, fatigue, and higher pressures and horsepower. The current invention overcomes these difficulties by a technique referred to as sculpturing the normally flat end surface of the front side of the fluid end. This technique can be used to balance the forces within the fluid portion of the pump. This technique also allows for higher pressure with no increase in mass. These and other advantages of the invention will be more fully explained in the detailed description of the invention which follows.

### BRIEF SUMMARY OF THE INVENTION

The essence of the invention is the discovery that by varying the shape, that is, sculpturing the front side of the fluid end of a high pressure pump, the internal stresses within the fluid housing can be controlled. This allows the pump to be designed in such a manner so as to minimize the mass of the pump end to minimize the possibility of structural failure. For example a frac pump can be designed so that the tendency of the fluid end of the pump to be pumped off the power end is minimized as well as lowering the occurrence of structural failure within the housing due to internal pressure.

### BRIEF DESCRIPTION OF THE SEVERAL VIEWS OF THE DRAWING(S)

FIG. 1 is a perspective view of a fluid end of a conventional frac pump.

FIG. 2a is a perspective view of a conventional fluid end having one pump chamber.

FIG. 2b is a cross section of the fluid end of FIG. 2a.

FIG. 3a is a perspective view of a fluid end of a pump according to one embodiment of the invention.

FIG. 3b is a cross section of the fluid end of FIG. 3a.

FIG. 4a is a perspective view of a fluid end of a pump according to a second embodiment of the invention.

FIG. 4b is a cross sectional view of the fluid end of FIG. 4a.

FIG. 5a is a perspective view of a fluid end of a pump according to a third embodiment of the invention.

FIG. 5b is a cross sectional view of the fluid end of FIG. 5a.

FIG. 6a is a perspective view of a fluid end of a pump according to a fourth embodiment of the invention.

FIG. 6b is a cross sectional view of the fluid end of FIG. 6Aa

FIG. 7a is a perspective view of a fluid end of a frac pump according to a further embodiment of the invention.

FIG. 7b is a cross sectional view of the embodiment of FIG. 7a.

FIG. 8a is a perspective view of a further embodiment of the invention.

FIG. 8b is a cross sectional view of the embodiment of FIG. 8a.

FIG. 9a is a perspective view of a further embodiment of the invention.

FIG. 9b is a cross sectional view of the embodiment of FIG. 9a.

FIG. 10 is a perspective view of the fluid end attached to the power end of a high pressure pump.

### DETAILED DESCRIPTION OF THE INVENTION

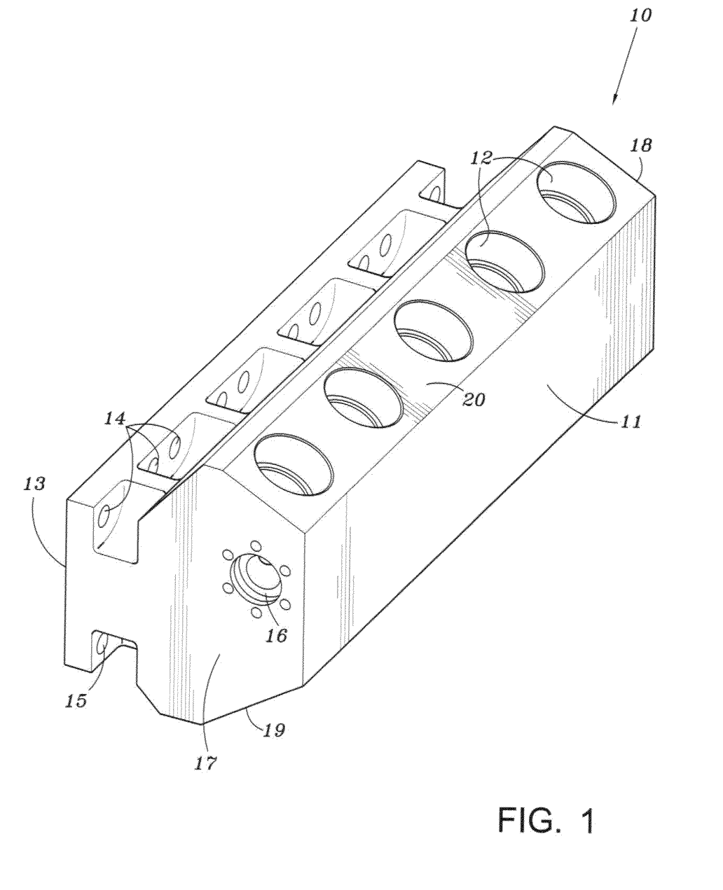

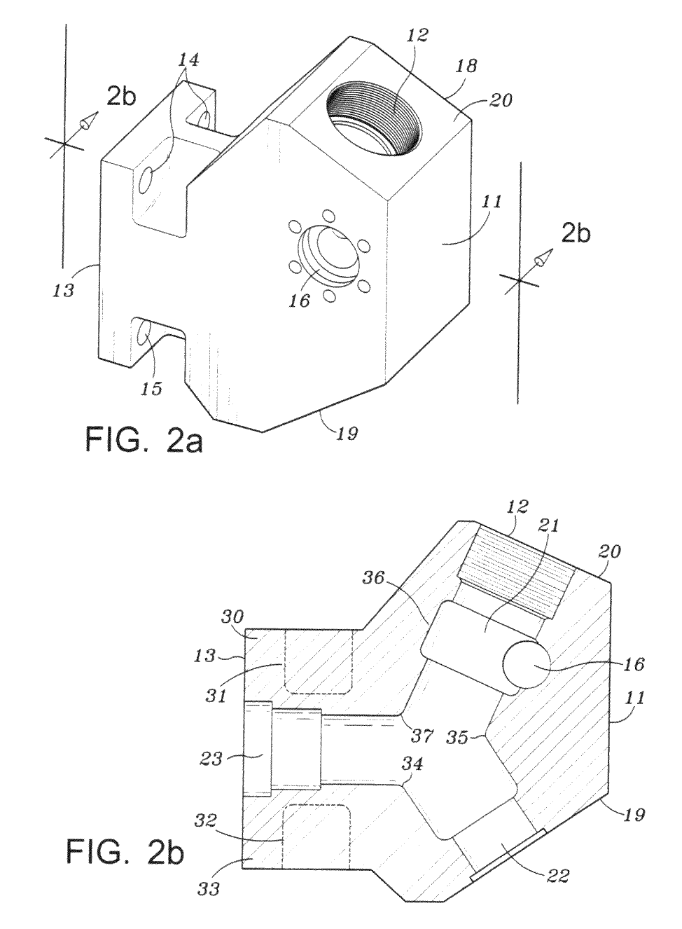

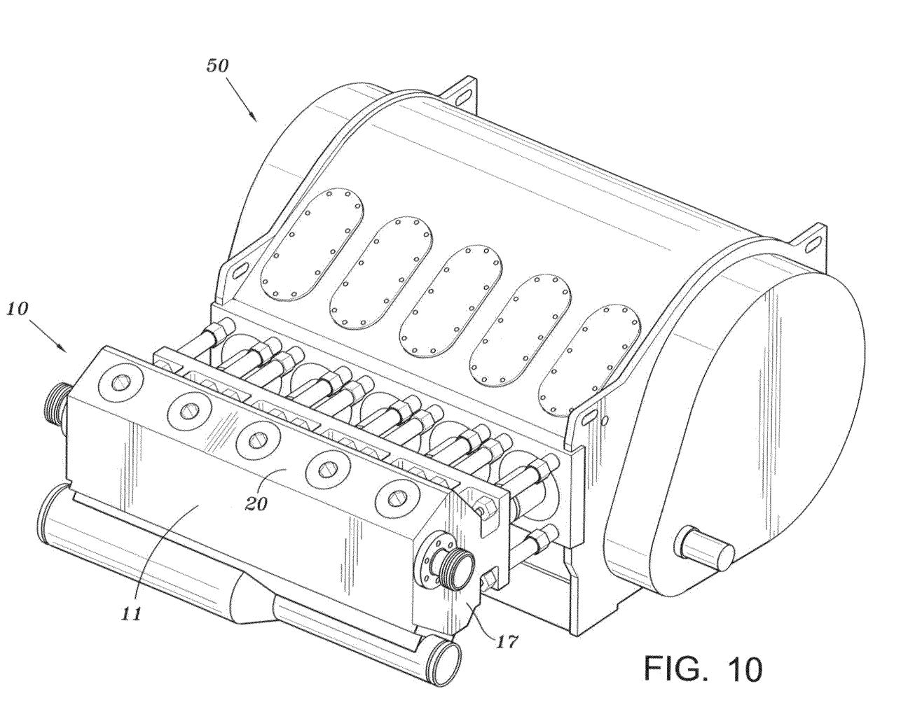

FIG. 1 illustrates a conventional fluid end 10 of a high pressure pump. The fluid end includes an inclined top surface 20 having a plurality of bores 12 for receiving outlet valve mechanisms which are not shown. Fluid end 10 has a planar front side 11 and a rear side 13 that is adapted to be bolted to the power end 50, shown in FIG. 10. Suitable bores 14, 15 are provided for receiving threaded bolts. A horizontally extending outlet passageway 16 is in fluid communication with each of the outlet chambers 21 of the pumps as shown in FIG. 2B. Fluid end 10 further includes a lower extending inclined portion 19. A plurality of inlet ports 22 are located in portion 19. Planar front side portion 11 externals vertically between inclined surfaces 20 and 19 when the pump is secured to a truck bed. The rear side 13 of the fluid end includes a plurality of bores 23 for receiving the pistons (not shown) which are driven by the power end of the pump. The arrangement of the pistons, the fluid inlet, and the fluid outlet is commonly referred to as the “Y” design for a frac pump as shown in FIG. 2b. However, a “T” configuration could also be used. Stress values at locations 30, 31, 32, 33, 34, 35, 36, and 37 shown in FIG. 2b were derived using finite element analysis techniques in order to demonstrate the principles of the invention. The solid model used for the analysis was created with Solid Works 2009—SP4.1 software. All the bores were completed exactly as shown in FIG. 2b. A pressure load in the bores was established as a baseline on all internal areas that see pressure. The baseline used is the current standard fluid end having a flat surface as shown in FIG. 2a. Cosmos Software was the finite element analysis software tool utilized in the tests. After establishing the baseline data, the only change made in the procedure was the configuration of the front face of the fluid end. The distance from the rear side 13 to the front side was 21.75 inches. Subsequent models indicated that as the distance became greater than 23 inches, sculpturing has very little effect on the stress levels. Von Mises stresses for the various locations in the standard design of FIG. 2b are as follows:

| POSITION | Von Mises Stress (PSI) |
|---|---|
| 30 | 4389 |
| 31 | 3986 |
| 32 | 4803 |
| 33 | 7751 |
| 34 | 49173 |
| 35 | 54940 |
| 36 | 32178 |
| 37 | 55806 |

The differences in stress at points 30 and 33 is believed to contribute to the tendency of the fluid end to separate from the power end.

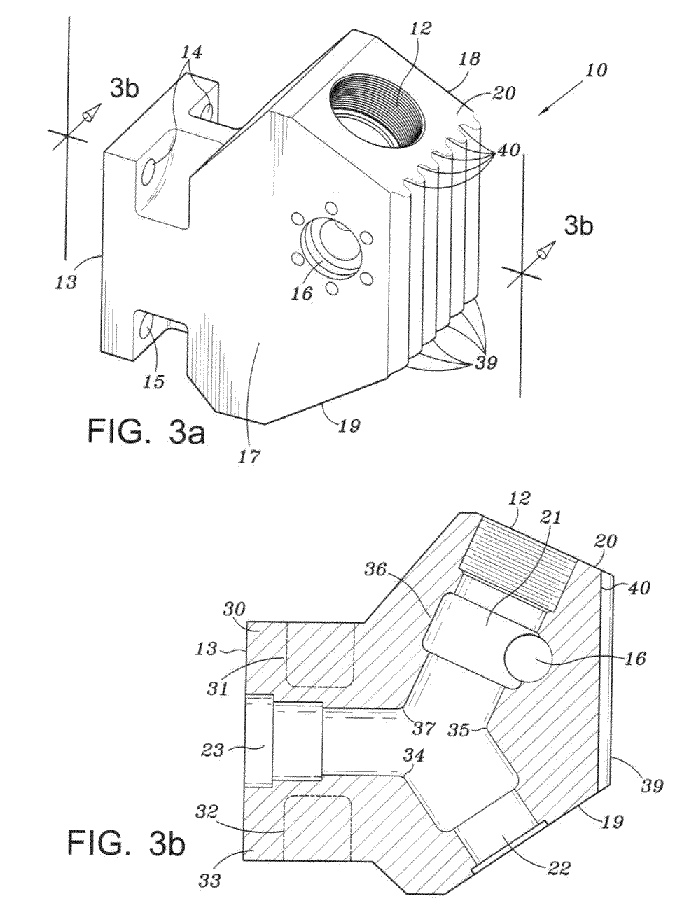

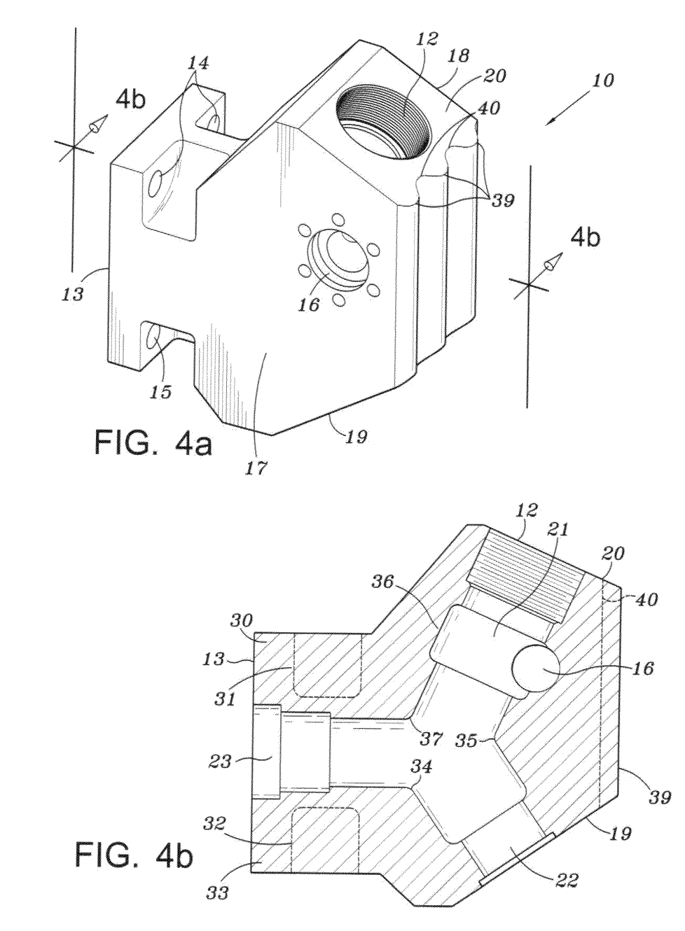

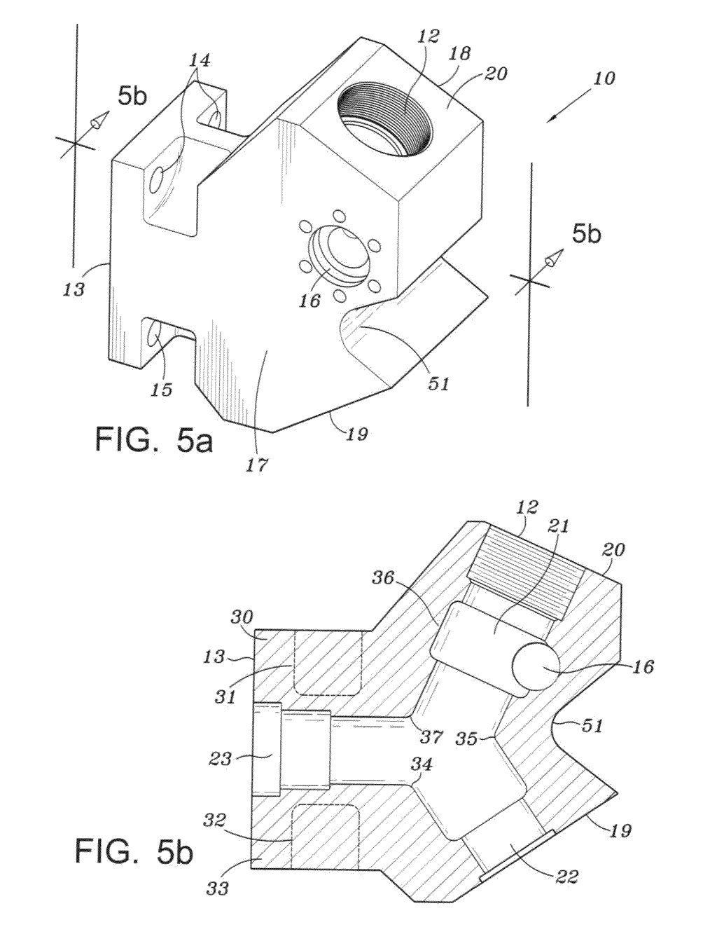

An embodiment of the principles of the present invention is shown in FIG. 3a. It should be noted that while FIGS. 2a through FIG. 9a show a single pump chamber, this is for convenience only and each embodiment may include several pump chambers located side by side in a common body as shown in FIG. 1. Referring the FIG. 3a, the fluid end of the pump is similar to that shown in FIG. 1 with the exception that the planar face 11 has been modified to have a plurality of vertically extending groves 40 and ribs 39. This change in the shape of the surface 11 of the fluid end portion of the pump has a significant impact on the pressure loads within and on the fluid end. FIG. 4a illustrates a second configuration wherein there are three vertically extending ribs provided on the outside surface with grooves 40 between the ribs. FIG. 5a illustrates another embodiment wherein a horizontally extending notch 51 is formed in the front side 11 of the fluid end of the pump.

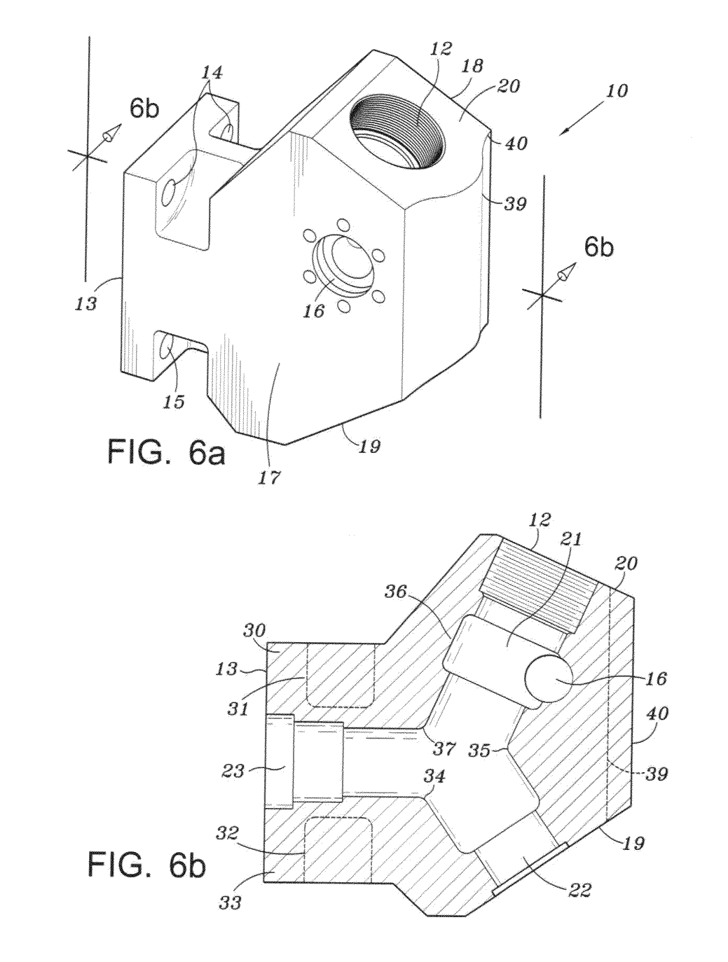

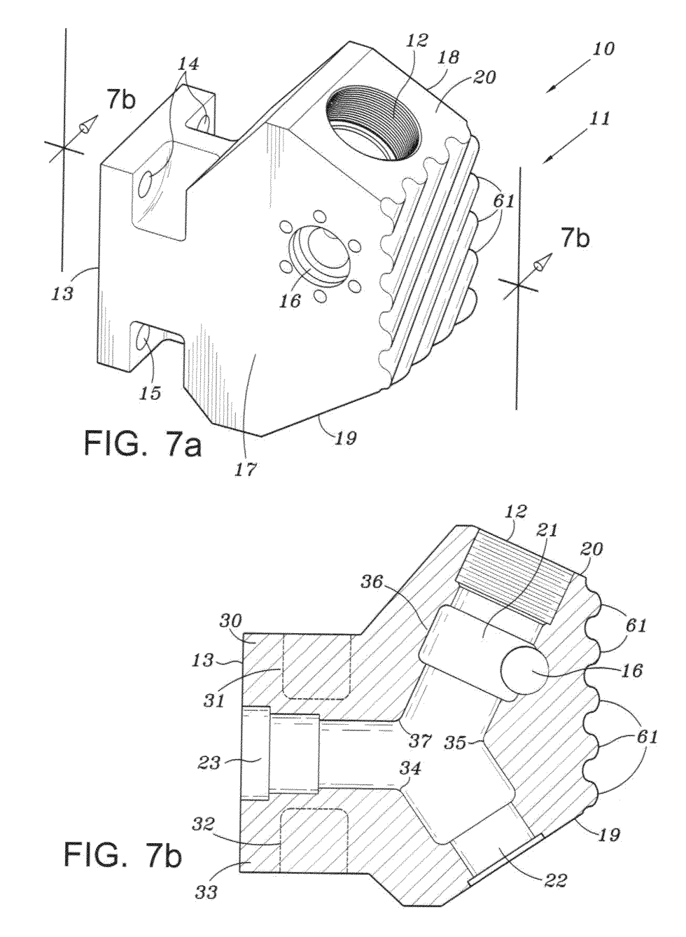

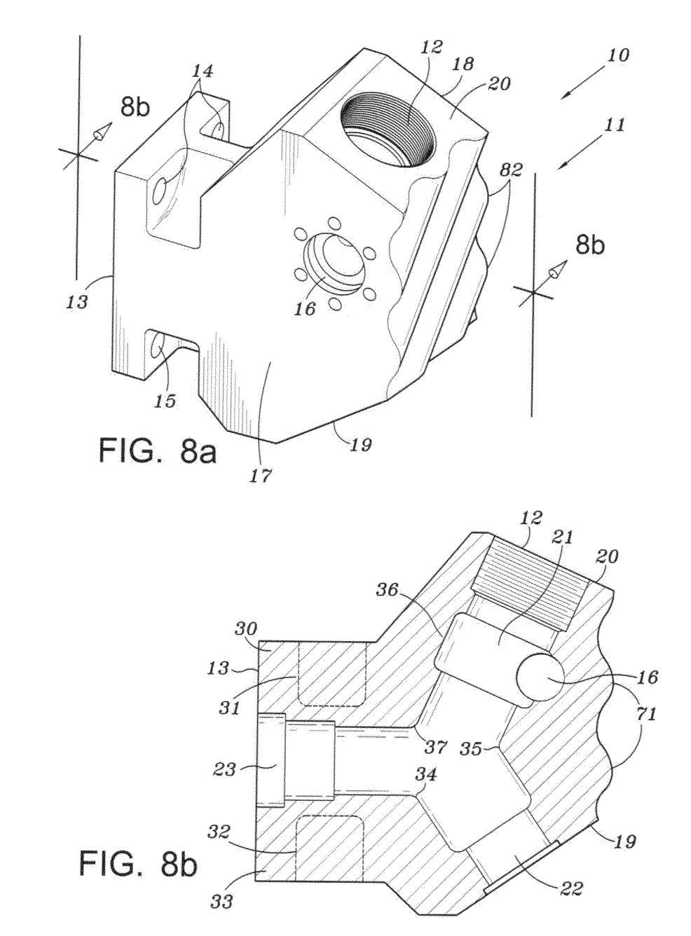

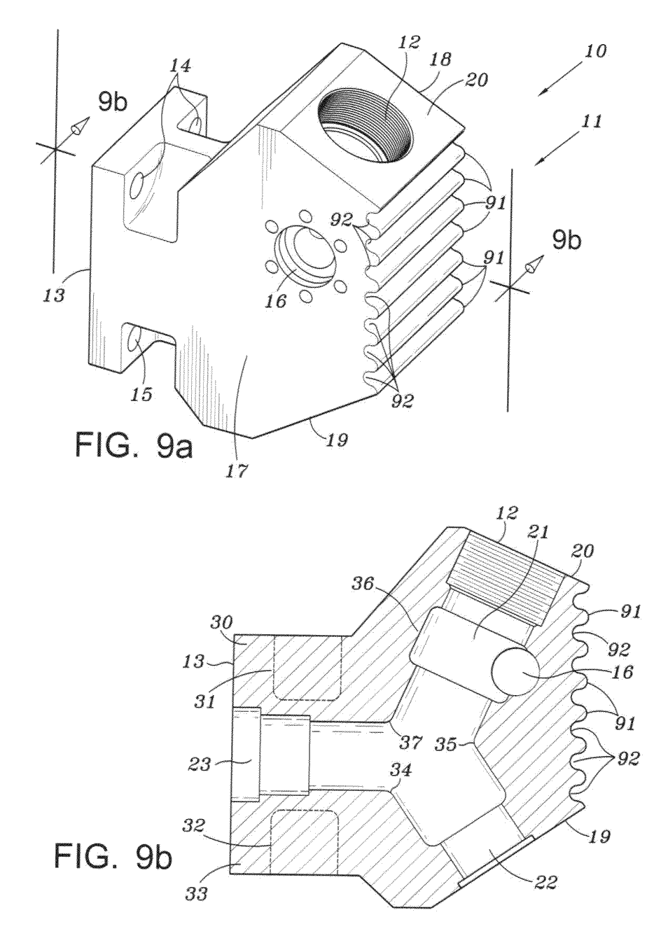

In the embodiment of FIG. 6a, a single wave-like rib 39 extends from the surface 11 of the fluid end of the pump. In the embodiment of FIG. 7a, a plurality of diagonal ribs 61, in this case 5, with grooves between them are provided on the front surface 11 of the fluid end. According to another embodiment, as shown in FIG. 8a the front surface is formed with two diagonally extending ribs 82 forming a wave like pattern. FIG. 9a illustrates an embodiment wherein six ribs 91 are formed in the end face with seven grooves 92.

The effects of the various designs of the front surface 11 of the various embodiments on the stress measured at points 30-37 are summarized in the following table:

TABLE 2
VON MISES STRESS VALUES FOR VARIOUS EMBODIMENTS S (PSI)

| | | FIG. 2b | FIG. 3b | FIG. 4b | FIG. 5b | FIG. 6b | FIG. 7b | FIG. 8b | FIG. 9b |
|---|---|---|---|---|---|---|---|---|---|
| Position | 30 | 4389 | 2367 | 6554 | 6050 | 4046 | 3630 | 4390 | 4240 |
| Locations | 31 | 3986 | 6864 | 9000 | 6853 | 4525 | 3921 | 4075 | 4025 |
| | 32 | 4803 | 2390 | 1832 | 1623 | 7000 | 5075 | 5190 | 4480 |
| | 33 | 7751 | 3031 | 1052 | 1276 | 7496 | 8460 | 8575 | 8340 |
| | 34 | 49173 | 49340 | 48656 | 47220 | 49200 | 47600 | 52760 | 49060 |
| | 35 | 54940 | 62156 | 65263 | 49730 | 53135 | 55720 | 52720 | 53675 |
| | 36 | 32178 | 36966 | 37908 | 31810 | 31020 | 31930 | 31310 | 33430 |
| | 37 | 55806 | 59930 | 56372 | 45960 | 50253 | 51425 | 50990 | 55600 |

The above table illustrates that the stress levels within the pump chamber and the forces working on the upper and lower portions of the inside face 13 of the fluid end of the pump can be dramatically changed by altering the shape of the front face 11 of the fluid end.

Based on this discovery, it is possible to select an appropriate design that will improve the reliability of the pump and increase its power handling capability with no increase in mass.

For example in the case of the embodiment of FIG. 3b, the stresses applied at positions 30 and 33 are such that the difference between the two has been reduced to 664 psi while the stress at point 33 of FIG. 3b has been reduced by 4720 psi compared to that at point 33 of FIG. 2b.

Although the present invention has been described with respect to specific details, it is not intended that such details should be regarded as limitations on the scope of the invention, except to the extent that they are included in the accompanying claims. For example, the inlet valves could be arranged in the top portion 20 of the fluid end and the outlet valves could be arranged in the bottom portion 19 of the fluid end. Outlet passageway 16 would then be relocated to the lower portion.

1. A fluid end assembly for a high pressure pump that includes a fluid end portion and a power portion comprising:
a housing having a front side, a rear side, and a bottom portion extending between the front and rear sides;
a top portion extending between the front side and the rear side;
the rear side having at least one bore for receiving a piston;
the top portion having at least one bore for accommodating a first valve;
the bottom portion having at least one bore for accommodating a second valve;
a outlet passageway extending within the housing; and
the front side having a non-planar surface.

2. The fluid end assembly of claim 1 wherein the first valve bore, second valve bore and the piston bore have axially extending axes that form a Y or T configuration.

3. The fluid end assembly of claim 1 wherein the exterior surface of the front side includes a plurality of grooves and ribs.

4. The fluid end assembly of claim 3 wherein the grooves and ribs extend in a generally vertical direction.

5. The fluid end assembly of claim 3 whereas the grooves and ribs extend in a generally horizontal direction.

6. The fluid end assembly of claim 1 wherein the exterior surface of the front side includes an inwardly extending horizontal notch.

7. The fluid end assembly of claim 1 wherein the rear side of the housing includes a plurality of bores adapted to receive bolts for attachment to the power end of the pump.

8. A method of making the fluid end portion of a high pressure pump comprising:
1) providing a solid piece of stock material having a planar front side surface;
2) forming at least one inlet and at least one outlet bore in the solid block;
3) forming at least one bore on the surface opposite the front side surface for receiving a piston; and
4) sculpturing the planar front side surface.

9. The method of claim 8 wherein the sculpturing step comprises forming a plurality of ribs on the front side.

10. The method of claim 8 wherein the sculpturing step includes forming a plurality of grooves in the front side surface.

11. The method of claim 8 wherein the sculpturing step includes forming a horizontally extending notch in the front side surface.

12. The method of claim 8 wherein the axis of the inlet, outlet and piston bores form a “Y” shape.

13. A pump comprising:
a power end portion,
a fluid end portion coupled to the power end portion,
the fluid end portion comprising:
a front side, a rear side, a bottom portion extending between the front and rear sides;
a top portion extending between the front side and the rear side,
the rear side portion having at least one bore for receiving a piston,
the top portion having at least one bore for accommodating a first valve,
the bottom portion having at least one bore for accommodating a second valve,
a outlet passageway extending within the housing, and
the front side having a non-planar surface.

14. A fluid end assembly according to claim 1 wherein the top portion includes a plurality of outlet valve bores and the bottom portion includes a plurality of inlet valve bores.

15. A pump according to claim 13 wherein the top portion includes a plurality of outlet valve bores with outlet valves positioned therein and the bottom portion includes a plurality of inlet valve bores with a plurality of inlet valves positioned therein.
